(19) United States
(12) Patent Application Publication
(10) Pub. No.: US 2016/0333510 A1
(43) Pub. Date: Nov. 17, 2016

(54) NON-WOVEN UNDERBODY SHIELD

(71) Applicant: Milliken & Company, Spartanburg, SC (US)

(72) Inventors: Pradipkumar Bahukudumbi, Greenville, SC (US); Kazuaki Shibata, Simpsonville, SC (US); Don A. Lovinggood, Simpsonville, SC (US)

(21) Appl. No.: 14/711,117

(22) Filed: May 13, 2015

(51) Int. Cl. D04H 1/4382; D04H 1/498; B32B 5/26; B32B 5/08; B32B 5/06; D04H 1/46; B32B 5/02

(52) U.S. Cl. CPC D04H 1/4382; D04H 1/46; D04H 1/498; B32B 5/022; B32B 5/08; B32B 5/06; B32B 5/26; B32B 2262/0253; B32B 2262/0276; B32B 2307/102; B32B 2307/304; B32B 2250/20; B32B 2305/28; B32B 2262/12; B32B 2307/718; D10B 2321/022; D10B 2331/04

(57) ABSTRACT

A needled, non-woven having a first zone extending from an upper surface to an inner plane and a second zone extending from the inner plane to a lower surface. The first zone comprises a plurality of first core/sheath fibers, a plurality of second fibers, and a plurality of third fibers, The second polymer forming the second fibers and the sheath polymer forming the sheath of the first core/sheath fibers have a critical surface energy less than 40 mN/m. The second zone comprises a plurality of fourth fibers and a plurality of fifth fibers. A portion of the first core/sheath fibers, second fibers, and third fibers from the first zone are physically entangled into the fourth fibers and fifth fibers in the second zone. A consolidated needled non-woven and method for making the needled non-woven and consolidated needled non-woven are also disclosed.

### TECHNICAL FIELD OF THE INVENTION

The invention provides a non-woven underbody shield, more particularly a non-woven underbody shield having good acoustic, mechanical and ice detachment properties.

### BACKGROUND

There are a number of products in various industries, including automotive, office and home furnishings, construction, and others; that require materials having a z-direction thickness to provide thermal, sound insulation, aesthetic, and other performance features. In many of these applications it is also required that the material be thermoformable to a specified shape and rigidity. In the automotive industry these products often are used for shielding applications such as noise and thermal barriers in automotive hood liners, underbody shields, and firewall barriers.

Broadly speaking, icing is the deposition of frozen water on surfaces at or below freezing. It may result from rain, freezing rain, sleet, wet snow, fog, or from spray or splashing water. Even above-freezing wet snow may, in some instances, stick to surfaces. Solid plastic parts, in general, do not suffer from ice adhesion problems due to the inherent high solidity of the part. Textile underbody shields need to be carefully engineered to reduce the adhesion of ice, so it will self-shed or be easier to remove mechanically.

Underbody shields are designed to be durable, absorb sound and to release ice easily. Unfortunately, there is typically a trade-off in one of these properties as the other is optimized. For example, a solid plastic underbody shield has good ice detachment properties but poor acoustic properties. Some non-woven textiles have good acoustic properties but poor ice detachment properties. Thus, there is a need for an underbody shield having good acoustic and ice detachment properties.

### BRIEF SUMMARY OF THE INVENTION

A needled, non-woven containing an upper surface, a lower surface, an inner plane, a first zone extending from the upper surface to the inner plane, and a second zone extending from the inner plane to the lower surface.

The first zone contains a plurality of first core/sheath fibers, a plurality of second fibers, and a plurality of third fibers. The core of the first core/sheath fibers contains a core polymer and the sheath of the first core/sheath fibers contains a sheath polymer. The core polymer has a higher melting temperature than the sheath polymer and the sheath polymer has a lower surface energy than the core polymer.

The second fibers contain a second polymer having a melting temperature less than the melting temperature of the core polymer of the first core/sheath fibers. The third fibers contain a third polymer having a melting temperature at least equal or greater than the melting temperature of the core polymer of the first core/sheath fibers. The second polymer and the sheath polymer of the first core/sheath fibers have a critical surface energy less than 40 mN/m and wherein the first zone comprises at least about 30% by weight first core/sheath fibers and second fibers.

The second zone contains a plurality of fourth fibers and a plurality of fifth fibers. The fourth fibers contain a fourth polymer having a melting temperature less than the melting temperature of the core polymer of the first core/sheath fibers. The fifth fibers comprise a fifth polymer having a melting temperature at least equal or greater than the melting temperature of the core polymer of the first core/sheath fibers. A portion of the first core/sheath fibers, second fibers, and third fibers from the first zone are physically entangled into the fourth fibers and fifth fibers in the second zone.

A consolidated needled non-woven and method for making the needled non-woven and consolidated needled non-woven are also disclosed.

### BRIEF DESCRIPTION OF THE FIGURES

An embodiment of the present invention will now be described by way of example, with reference to the accompanying drawings.

FIG. 1 illustrates schematically a cross-section of one embodiment of the needled non-woven.

FIG. 2 illustrates schematically a cross-section of one embodiment of the needled non-woven.

### DETAILED DESCRIPTION OF THE INVENTION

The present disclosure is directed to needled non-wovens and consolidated needled non-wovens that provide acoustical properties including, but not limited to, sound absorption properties, and sound barrier properties as well as good ice detachment properties. The needled non-wovens and consolidated needled non-wovens may also be molded for a variety of end uses such as underbody shields and fender liners for vehicles. The present disclosure is also directed to methods of making the non-wovens, as well as methods of using the non-wovens in a variety of sound absorbing applications.

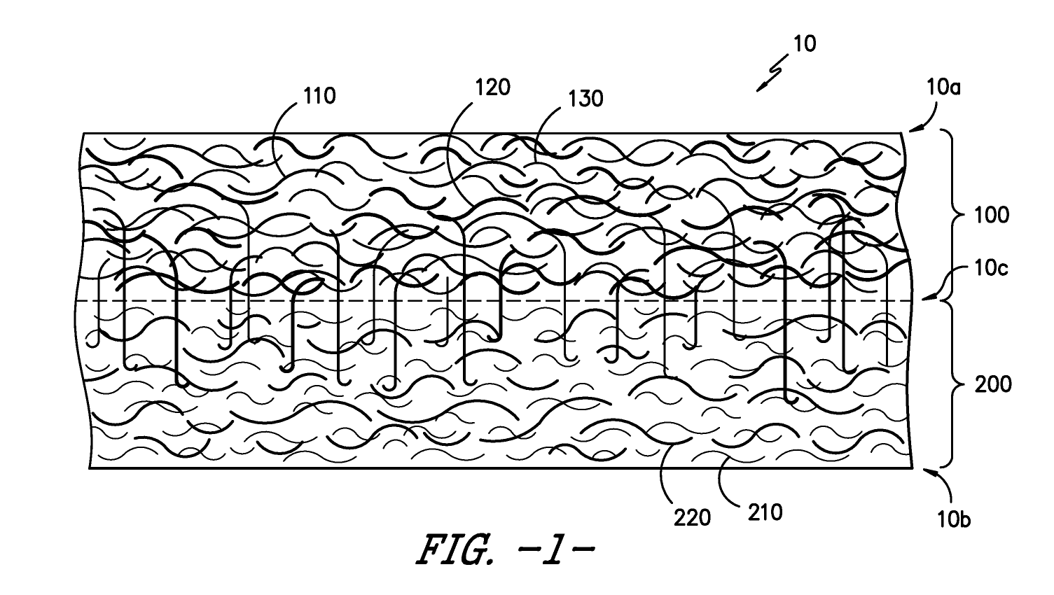

Referring to FIG. 1, there is shown one embodiment of a needle non-woven 10. The needled non-woven 10 has an upper surface 10a, a lower surface 10b, and an inner plane 10c. The needled non-woven 10 contains a first zone 100 extending from the upper surface 10a to the inner plane 10c and a second zone 200 extending from the inner plane 10c to the lower surface 10b.

The needled non-woven 10 is a unitary material where the inner plane 10c is not a distinct plane or an adhesive connecting two zones together, and the zones 100, 200 are areas within the unitary material. Preferably, the needled non-woven 10 is made from two non-wovens that are needled together from the upper surface 10a thereby joining the two layers together to form the zones 100, 200. Therefore, a portion of the fibers 110, 120, 130 from the first zone are pushed into the second zone 200 and are entangled with the fibers 210, 220 in the second zone 200. The first zone is preferably essentially free from fibers 210, 220 from the second zone.

Although FIG. 1 illustrates the first zone 100 and the second zone being approximately equal in thickness (thickness being defined as the distance between the upper surface 10a and the inner plane 10c for the first zone 100 and the distance between the inner plane 10c and the lower surface 10b for the second zone), the relative thickness of the two zones can be different than as shown. In one embodiment, the first zone has a thickness of 1.5 mm and a basis weight of 200 gram/m² and the second zone has a thickness of 3.5 mm and a basis weight of 400 gram/m². In another preferred embodiment, the first zone has a thickness of 2.5 mm and a basis weight of 300 gram/m² and the second zone has a thickness of 5.5 mm and a basis weight of 1000 gram/m².

In one embodiment, the first zone has a weight range between about 200-600 gsm and a thickness range between about 1.5 mm-3.5 mm. In another embodiment, the second zone has a weight range between about 400-1200 gsm and a thickness range is 3.5 mm-7 mm. The thickness range of the consolidated needled non-woven is preferably between 2.5 mm and 5 mm.

The needled non-woven 10 (and consolidated needled non-woven 20) contain the first zone 100 which comprises a plurality of first core/sheath fibers 110, a plurality of second fibers 120, and a plurality of third fibers 130. The first core/sheath fibers contain a core which comprises a core polymer and a sheath which comprises a sheath polymer. The core polymer has a higher melting temperature than the sheath polymer and the sheath polymer has a lower surface energy than the core polymer. The sheath polymer of the first core/sheath fibers has a critical surface energy less than 40 mN/m, more preferably less than 32 mN/m, more preferably less than 25 mN/m, and more preferably less than 20 mN/m. A useful concept in considering contact angle, wettability and adhesion is critical surface energy γ_{c}. For a given substrate, this is determined by measuring the contact angle θ with a series of similar liquids with different γ. Graphing cos (θ) vs. γ gives a linear plot, extrapolation of this to cos (θ)=1 shows the value γ_{c} for which wetting theoretically would be complete. To spread on a given substrate, a liquid must have γ≦γ_{c}. When the needled non-woven 10 is consolidated the sheath of the first sheath/core polymer partially to fully melt and act as a binder for the consolidated needled non-woven 20. This lower surface energy provides good ice detachment for the consolidated needled non-woven 20. In one preferred embodiment, the core polymer comprises polyester and the sheath polymer comprises polyethylene.

Reducing the adhesion of ice to a porous substrate requires reducing the substrate's wettability, thereby making it more hydrophobic. This means reducing its reactivity and surface forces, making it more inert, and more incompatible with water. The resulting higher contact angle makes it more likely to occlude air at the interface. Water is prone to hydrogen bonding, which is the basis of the ice structure, and thus water and ice are attracted to a substrate having H-bondable components; i.e. oxygen atoms. A low adhesion surface should, then, be free of oxygen atoms, or have them well screened by more inert atoms or groups (e.g. silicones). A high energy surface, exhibiting high interfacial energy, has high attraction for a contacting liquid and low energy surface the opposite. As is made clear above, conditions for low ice adhesion, releasing or parting from porous fiber surfaces include—1) low energy surfaces, 2) absence of contamination of the surface by high surface energy impurities, 3) occlusion of air at the interface to impair bonding and promote stress concentrations that can initiate and propagate ice cracks and failure, and 4) an optimum degree of surface roughness to encourage co-planar air entrapment. The use of bicomponent fibers, where-in the sheath has a low critical surface tension, allows for the formation of substrates that satisfy the above criteria without compromising the sound absorption properties. Binder fibers that fully melt create a smooth, film-like surface that can be brittle and prone to cracking under deformation.

The first zone 100 also contains second fibers 120 which contain a second polymer having a melting temperature less than the melting temperature of the core polymer of the first core/sheath fibers. These fibers are typically referred to as binder fibers (the first core/sheath fibers may also sometimes be characterized as binder fibers also) and also may help with molding the substrate into complex geometries while improving mechanical properties.

The second fibers 120 within the first zone 100 are bonded together when the needled non-woven 10 is consolidated to create a cohesive two-dimensional fiber network which anchors the other fibers 110, 130 within the non-woven. The binder fibers are fibers that form an adhesion or bond with the other fibers. In one embodiment, the binder preferably are fibers that are heat activated. Examples of heat activated binder fibers are fibers that can melt at lower temperatures, such as low melt fibers, bi-component fibers, such as side-by-side or core and sheath fibers with a lower sheath melting temperature, and the like. Preferably, the second fibers have a melting temperature of less than about 165° C., more preferably less than about 140° C. Preferably, the second polymer comprises polypropylene.

The binder fibers are preferably staple fibers. In one embodiment, the binder fibers are discernable fibers. In another embodiment, the binder fibers lose their fiber shape and form a coating on surrounding materials (when consolidated).

In one preferred embodiment, the second polymer has a critical surface energy less than 40 mN/m, more preferably less than 32 nN/m, more preferably less than 25 nN/m, and more preferably less than 20 nN/m. Critical surface energy is measured by observing the spreading behavior and contact angle of a series of liquids of decreasing surface tension. A rectilinear relationship exists between the cosine of the contact angle and surface tension of the wetting liquid; the intercept of this line with the zero contact angle line gives a value of the critical surface energy, which is independent of the nature of the test liquid and is a parameter characteristic of the solid surface only. This lower surface energy provides good ice detachment for the consolidated needled non-woven 20. Preferably, the binder fibers 40 have a denier less than or about equal to 15 denier, more preferably less than about 6 denier. In one embodiment, at least some of the binder fibers are nano-fibers (their diameter is less than one micrometer).

Preferably, the first zone contains at least about 30% by weight of the first core/sheath fibers and the second fibers, more preferably at least about 40%, more preferably at least about 50%, more preferably at least about 60%, more preferably at least about 70% by weight. In another embodiment, the first zone contains between about 30 and 70% by weight first core/sheath fibers and the second fibers. In a preferred embodiment, the first zone contains 75% by weight of first core/sheath fibers and the second fibers, and 25% by weight of the third fibers. This allows for a maximal coverage of low critical surface energy fibers on the surface, while providing the right combination of rigidity and flexibility without elasticity at the interface to attain low ice adhesion. The third fiber helps to provide the necessary surface roughness or “hairy structures”. The hair structures with low surface energy character shed water or cause formation of gaseous plastrons (shield of occluded air), thereby minimizing the amount of water absorbed by the non-woven material.

The third fibers 130 comprise a third polymer having a melting temperature at least equal or greater than the melting temperature of the core polymer of the first core/sheath fibers. In one embodiment, these fibers are sometimes referred to as bulking fibers and do not melt (to an appreciable amount) when the needled non-woven 10 is consolidated. In another embodiment, the third fiber 130 is a core-sheath fiber wherein the core comprises the third polymer having a melting temperature lower than the melting temperature of the core polymer of the first core/sheath fibers. In another embodiment, the third polymer has a melting temperature at least 10 degrees greater than the melting temperature of the sheath polymer of the first core/sheath fibers. Preferably, the third polymer comprises polyester.

Bulking fibers are fibers that provide volume to the needled non-woven 10. Examples of bulking fibers would include fibers with high denier per filament (one denier per filament or larger), high crimp fibers, hollow-fill fibers, and the like. These fibers provide mass and volume to the material. Some examples of bulking fibers include polyester, polypropylene, and cotton, as well as other low cost fibers. Preferably, the bulking fibers have a denier greater than about 6 denier. In another embodiment, the bulking fibers have a denier greater than about 15 denier. The bulking fibers are preferably staple fibers. In one embodiment, the bulking fibers do not a circular cross section, but are fibers having a higher surface area, including but not limited to, segmented pie, 4DG, winged fibers, tri-lobal etc.

In one embodiment, the third fibers 130 within the first zone 100 are randomly oriented within the first zone 100. In another embodiment, a majority of third fibers 130 are oriented such that the fibers form an angle with the inner plane 10c of between about 0 and 25 degrees. In another embodiment, the third fibers 130 preferably are oriented generally in the z-direction (the z-direction is defined as the direction perpendicular to the inner plane 10c. The z-orientation of the third fibers 130 allows for increased thickness of the first zone 100. In this embodiment, preferably a majority of the third fibers 130 have a tangential angle of between about 25 and 90 degrees to the normal of midpoint plane between the upper surface 10a and the inner plane 10c. This means that if a tangent was drawn on the third fibers 130 at the midpoint between the upper surface 10a and the inner plane 10c, the angle formed by the tangent and the midpoint plane would be between about 90 degrees and 25 degrees.

Referring back to FIG. 1, the second zone contains a plurality of fourth fibers 210 and a plurality of fifth fibers 220. The fourth fibers 210 comprise a fourth polymer having a melting temperature less than the melting temperature of the core polymer of the first core/sheath fibers 110 (in the first zone 100) and may be referred to as a binder fiber. The fourth fiber 210 is similar (and may be the same fiber) as the second fiber 120 in the first zone 100. All descriptions of materials and properties for the second fiber 120 are applicable to the fourth fiber 140. In one embodiment, the fourth fibers 210 comprise the same polymer as the second fibers 120. In another embodiment, the fourth fibers 210 and the second fibers 210 are the exact same fibers.

The fifth fibers 220 comprise a fifth polymer having a melting temperature at least equal or greater than the melting temperature of the core polymer of the first core/sheath fibers from the first zone 100 and may be referred to as a bulking fiber. The fifth fiber 220 is similar (and may be the same fiber) as the third fiber 130 in the first zone 100. All descriptions of materials and properties for the third fiber 130 are applicable to the fifth fiber 220. In one embodiment, the fifth fibers 220 comprise the same polymer as the third fibers 130. In another embodiment, the fifth fibers 220 and the third fibers 130 are the exact same fibers.

In one embodiment, the second zone 200 additionally contains second core/sheath fibers. The second core/sheath fibers are similar (and may be the same fiber) as the first core/sheath fibers 110 in the first zone 100. All descriptions of materials and properties for the first core/sheath fibers are applicable to the second core/sheath fibers.

In one embodiment, the needled non-woven 10 (and consolidated needled non-woven 20) contains additional fibers in the first zone 100 and/or the second zone 200. The additional fibers may be uniformly distributed throughout the non-woven 10, 20 and or the zones 100, 200 or may have a stratified concentration. These additional fibers may include, but are not limited to additional binder fibers having a different denier, staple length, composition, or melting point, additional bulking fibers having a different denier, staple length, or composition, and an effect fiber, providing benefit a desired aesthetic or function. These effect fibers may be used to impart color, chemical resistance (such as polyphenylene sulfide fibers and polytetrafluoroethylene fibers), moisture resistance (such as polytetrafluoroethylene fibers and topically treated polymer fibers), or others.

In one embodiment, the additional fibers may be heat and flame resistant fibers, which are defined as fibers having a Limiting Oxygen Index (LOI) value of 20.95 or greater, as determined by ISO 4589-1. Examples of heat and flame resistant fibers include, but are not limited to the following: fibers including oxidized polyacrylonitrile, aramid, or polyimid, flame resistant treated fibers, FR rayon, carbon fibers, or the like. These heat and flame resistant fibers may also act as the bulking fibers or may be used in addition to the bulking fibers.

All of the fibers within the needled non-woven 10 (and consolidated needled non-woven 20) may additionally contain additives. Suitable additives include, but are not limited to, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, fire retardants, and fluoropolymers. One or more of the above-described additives may be used to reduce the weight and/or cost of the resulting fiber and layer, adjust viscosity, or modify the thermal properties of the fiber or confer a range of physical properties derived from the physical property activity of the additive including electrical, optical, density-related, liquid barrier or adhesive tack related properties.

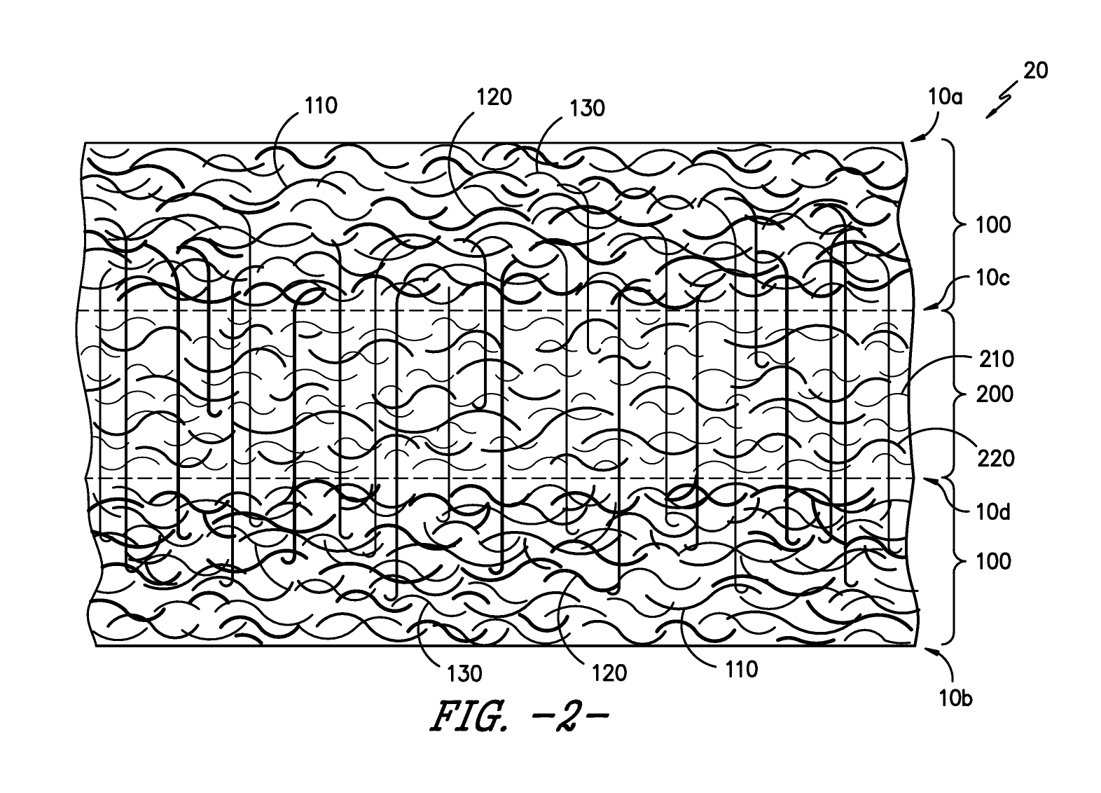

In one embodiment shown in FIG. 2, there is an additional first zone 100 located on the lower surface of the second zone. The additional first zone may be exactly same as the first zone or may have different fibers, densities, and ratios. The properties described in relation to the first zone (fibers, etc) are applicable to the additional first zone. In this embodiment, the surfaces of the first zones 100 form both of the outer surfaces of the non-woven 10. When needled together, the needling can be done from one side or preferably from both sides of the non-woven 10 thus interlocking the zones together and forming two inner planes 10c and 10d.

In another embodiment, the non-woven 10 contains an additional first zone located on the first zone and/or an additional second zone located on the second zone. This is a way of creating a thicker non-woven, having multiple zones of the same type adjacent each other. The properties described in relation to the first zone (fibers, etc) are applicable to the additional first zone. The properties described in relation to the second zone (fibers, etc) are applicable to the additional second zone. When needled together, the needling can be done from one side or preferably from both sides of the non-woven 10 thus interlocking all of the zones together.

The process to form the needled non-woven begins with two non-wovens. The first non-woven is formed by needling together at least the first core/sheath fibers, second fibers, and third fibers. The second non-woven is formed by needling together at least the fourth fibers and fifth fibers. These two non-wovens, the first non-woven and second non-woven, preferably have enough physical integrity so that they may be moved and handled independently. The needle punched layers can be produced using a standard industrial scale needle punch carpet production line. Staple fibers as indicated may be mixed and formed in a bat or mat using carding and cross-lapping. The mat may be then pre-needled using plain barbed needles to form the non-woven layers.

The two non-wovens are stacked such that the first non-woven is on top and adjacent the second non-woven (preferably in direct contact with no additional fibers, layers, or adhesives between them) and then the two non-wovens are needled together, preferably only from the first non-woven side.

This needling causes the two non-woven layers to form the needled non-woven 10 where the upper surface of the first non-woven forms the upper surface 10a of the needled non-woven 10, the lower surface of the second non-woven forms the lower surface 10b of the needled non-woven 10 and the where the two non-wovens meet forms the inner plane 10c. Needling only from the first non-woven side pushes a portion of the fibers from the first non-woven (fibers 110, 120, 130) into the second non-woven and entangles them with the fibers (210, 220) within the second non-woven. Preferably, there are essentially no fibers from the second non-woven needled into the first non-woven.

The formed needled non-woven may then be used as is or may be subjected to one or more consolidation steps. Consolidation is performed under heat and optionally pressure and may result in a flat consolidated needled non-woven or a molded three-dimensional consolidated needled non-woven. In one embodiment, the consolidation step includes both heat and pressure. The consolidation serves to at least partially melt the sheath of the first core/sheath fibers 110, the second fibers 120, and the fourth fibers 210.

Preferably, the consolidated needled non-woven layer has a lower thickness than the needle non-woven layer. Preferably, the consolidated needled non-woven layer has a higher stiffness than the needle non-woven layer. Preferably, the consolidated needled non-woven layer has a higher solidity than the needle non-woven layer. “Solidity” is a non-woven web property inversely related to density and characteristic of web permeability and porosity (low solidity corresponds to high permeability), and is defined by the equation:

Solidity (%)=[3.937*Areal weight (g/m²)]/[Thickness (mils)*Density (g/cm³)]

The unconsolidated non-woven has a solidity of between about 5 and 15%, more preferably between about 5 and 10%. The solidity of the non-woven after consolidation is between about 20 and 40%, more preferably between about 20 and 30%. Preferably, the first non-woven and second non-woven have a higher cohesive strength in the consolidated needled non-woven layer than the first non-woven and the second non-woven of the needle non-woven layer. Following the needle-punching step, the resulting composite was passed through a through-air pre-heat oven in which air heated to a temperature of approximately 175° C. (347° F.) was passed through the composite to partially melt the low-melt and binder fibers in the first and second zone. This sample was then consolidated to a solidity between 20 and 40% using a double-belt compression oven in which the belts were heated to a temperature of approximately 204° C. (400° F.). The consolidation method should be carefully chosen to maintain an optimum degree of roughness-smoothness to encourage co-planar air entrapment to facilitate ice shedding or parting. Contact heat is generally preferred to create such a surface. The coefficient of dynamic friction as measured on the first surface, is between 0.10 and 0.25, and more preferably between 0.10 and 0.22. After passing through the compression oven, the contact heat from the belt, forms a porous skin on the surface of the first zone, as a result of the low-melt fibers and binder fibers melting out. This provides a high air-flow resistive face to the composite material, thereby enhancing sound absorption at low frequencies. Also, the consolidated material has low ice adhesion and water absorption properties due to the high concentration of low surface energy fibers in the first zone.

The average of the absorption coefficient was calculated by averaging the sound absorption coefficient over all frequencies from 500 to 4000 Hz. The average sound absorption coefficient was greater than 0.65, more preferably greater than 0.7. The ice detachment properties were evaluated by measuring the normal force required to remove a frozen volume of ice from the first surface. The normal force was less than 12 N, more preferably less than 0.5 N.

### Test Method

US patent application 20040038046 details a testing device for measurement of the load required for sliding movement of ice and for examination of the condition of the ice sliding movement on solid surfaces. A modified version of this test method is used here to measure the normal force required to detach ice from non-woven substrates. The sample size used is 100 mm×100 mm. A circular metal cylinder is placed on top of the sample. The cylindrical fixture has a circular hook welded to the surface of the cylinder. Water is poured into the cylindrical fixture and kept in a freezer at −15 C for 150 minutes. To prevent breaking/cracking of ice due to expansion, the water needs to be iced gradually. At the end of 150 minutes, a force gage is attached to the hook and the normal force required to remove the fixture from the surface of the non-woven is measured. The appearance of the sample immediately after ice detachment is recorded (any fiber separation or delamination).

### EXAMPLES

The invention will now be described with reference to the following non-limiting examples, in which all parts and percentages are by weight unless otherwise indicated.

### Example 1

Example 1 was a consolidated non-woven fiber based composite comprising a first zone and a second zone. The non-woven layer forming the first zone was formed from a blend of three fibers and had a basis weight of 200 gram/m²:

1) 50% by weight of a 1.8 denier polyester core-polyethylene sheath fiber. 2) 25% by weight of a 5 denier polypropylene fiber.

3) 25% by weight of a 4 denier (4.4 decitex) low melt binder fiber. The fiber is a core-sheath polyester fiber with a lower melting temperature sheath.

The non-woven layer forming the second zone was formed from a blend of three fibers and had a basis weight of 450 gram/m²:
1) 50% by weight of a 6 denier polyester staple fiber.
2) 25% by weight of a 5 denier polypropylene fiber.
3) 25% by weight of a 4 denier (4.4 decitex) low melt binder fiber. The fiber is a core-sheath polyester fiber with a lower melting temperature sheath.

The non-woven layers forming the zones were produced using a standard industrial scale needle punch carpet production line. Staple fibers as indicated above were mixed and formed in a mat using carding and cross-lapping. The mat was pre-needled using plain barbed needles to form the non-woven layers. The first zone (first non-woven) and second zone (second non-woven) were then needled together using a needle-loom from the first zone side of the non-woven. The needling pushed fibers from the first zone into the second zone and essentially no fibers from the second zone were in the first zone. The non-woven was then consolidated using a double belt compression oven set at 400° F. to melt the low-melt and binder fibers. The consolidated non-woven composite had a thickness of 2.5 mm.

### Example 2

Example 2 was a consolidated non-woven fiber based composite comprising a first zone, second zone and third zone. The non-woven layer forming the first zone was formed from a blend of three fibers and had a basis weight of 300 gram/m²:
1) 50% by weight of a 1.8 denier polyester core-polyethylene sheath fiber.
2) 25% by weight of a 5 denier polypropylene fiber.
3) 25% by weight of a 4 denier (4.4 decitex) low melt binder fiber. The fiber is a core-sheath polyester fiber with a lower melting temperature sheath.

The non-woven layer forming the second zone was formed from a blend of three fibers and had a basis weight of 600 gram/m²:
1) 50% by weight of a 6 denier polyester staple fiber.
2) 25% by weight of a 5 denier polypropylene fiber.
3) 25% by weight of a 4 denier (4.4 decitex) low melt binder fiber. The fiber is a core-sheath polyester fiber with a lower melting temperature sheath.

The third zone was identical in construction and composition to the first zone.

The first zone, second and third zones were needled together using a needle-loom and then consolidated using a double belt compression oven set at 400° F. to melt the low-melt and binder fibers. *The needling was conducted from the first size, both sides? Describe resultant fibers within the non-woven composite. The consolidated non-woven composite had a thickness of 4 mm.

### Example 3

Example 3 was a unitary needled non-woven fiber based composite. The non-woven layer in the first zone was formed from a blend of four fibers and had a basis weight of 650 gram/m²:
1) 30% by weight of a 1.8 denier polyester core-polyethylene sheath fiber.
2) 20% by weight of a 5 denier polypropylene fiber.
3) 20% by weight of a 4 denier (4.4 decitex) low melt binder fiber. The fiber is a core-sheath polyester fiber with a lower melting temperature sheath.
4) 20% by weight of a 6 denier polyester staple fiber.

The non-woven was consolidated using a double belt compression oven set at 400° F. to melt the low-melt and binder fibers. The consolidated non-woven composite had a thickness of 2.5 mm.

### Example 4

Example 4 was a unitary needled non-woven fiber based composite. The non-woven layer forming the first zone was formed from a blend of three fibers and had a basis weight of 650 gram/m²:
1) 50% by weight of a 1.8 denier polyester core-polyethylene sheath fiber.
2) 25% by weight of a 5 denier polypropylene fiber.
3) 25% by weight of a 4 denier (4.4 decitex) low melt binder fiber. The fiber is a core-sheath polyester fiber with a lower melting temperature sheath.

The non-woven was consolidated using a double belt compression oven set at 400° F. to melt the low-melt and binder fibers. The consolidated non-woven composite had a thickness of 2.5 mm.

### Example 5

Example 5 was a unitary needled non-woven fiber based composite. The non-woven layer forming the first zone was formed from a blend of two fibers and had a basis weight of 900 gram/m²:
1) 70% by weight of a 5.4 denier polyester fiber with a silicone finish.
2) 30% by weight of a 4 denier (4.4 decitex) low melt binder fiber. The fiber is a core-sheath polyester fiber with a lower melting temperature sheath.

The non-woven was consolidated using a double belt compression oven set at 400° F. to melt the low-melt and binder fibers. The consolidated non-woven composite had a thickness of 5.5 mm.

### Results

TABLE 1
Thickness, areal density, and ice detachment force of Examples

| | Thickness | Areal Density | Ice detachment force |
|---|---|---|---|
| Example | (mm) | (g/m²) | (N) |
| 1 | 2.5 | 650 | 0.09 |
| 2 | 4 | 1200 | 0.10 |
| 3 | 2.5 | 650 | 45.6 |
| 4 | 2.5 | 650 | 11.4 |
| 5 | 5.5 | 900 | 12.2 |

As it can be seen from the table above, a multi-layer construction with a high concentration of low critical surface energy staple fibers (examples 1 and 2), reduces the normal force required to release a volume of ice from the non-woven surface. When the low surface energy fibers are homogeneously blended with higher surface energy fibers (39 mN/m) to form a unitary non-woven composite as in Example 3, the ice detachment properties can be severely compromised. Examples 4 and 5 detail constructions with homogenously blended fibers with low surface energy (<39 mN/m) with improved ice detachment properties compared to Example 3. Also, as the ice attachment performance is achieved by a careful selection of fibers and non-woven construction, instead of a topical surface chemistry treatment or adhesively bonding functional layers, the solution is more environmentally durable.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A needled, non-woven comprising:
an upper surface, a lower surface, an inner plane, a first zone extending from the upper surface to the inner plane, and a second zone extending from the inner plane to the lower surface;
wherein the first zone comprises a plurality of first core/sheath fibers, a plurality of second fibers, and a plurality of third fibers, wherein the core of the first core/sheath fibers comprises a core polymer, wherein the sheath of the first core/sheath fibers comprises a sheath polymer, wherein the core polymer has a higher melting temperature than the sheath polymer, wherein the sheath polymer has a lower surface energy than the core polymer, wherein the second fibers comprise a second polymer having a melting temperature less than the melting temperature of the core polymer of the first core/sheath fibers, wherein the third fibers comprise a third polymer having a melting temperature at least equal or greater than the melting temperature of the core polymer of the first core/sheath fibers, wherein the second polymer and the sheath polymer of the first core/sheath fibers have a critical surface energy less than 40 mN/m, and wherein the first zone comprises at least about 30% by weight first core/sheath fibers and second fibers;
wherein the second zone comprises a plurality of fourth fibers, and a plurality of fifth fibers, wherein the fourth fibers comprise a fourth polymer having a melting temperature less than the melting temperature of the core polymer of the first core/sheath fibers, wherein the fifth fibers comprise a fifth polymer having a melting temperature at least equal or greater than the melting temperature of the core polymer of the first core/sheath fibers; and,
wherein a portion of the first core/sheath fibers, second fibers, and third fibers from the first zone are physically entangled into the fourth fibers and fifth fibers in the second zone.

2. The needled, non-woven of claim 1, wherein the second zone further contains second core/sheath fibers.

3. The needled, non-woven of claim 1, wherein the second polymer and the sheath polymer of the first core/sheath fibers have a critical surface energy less than 32 mN/m.

4. The needled, non-woven of claim 1, wherein the first zone comprises essentially no fourth fibers and no fifth fibers.

5. The needled, non-woven of claim 1, wherein the core polymer comprises polyester and the sheath polymer comprises polyethylene.

6. The needled, non-woven of claim 1, wherein the second polymer comprises polypropylene.

7. The needled, non-woven of claim 1, wherein the third polymer comprises polyester.

8. The needled, non-woven of claim 1, wherein the fourth polymer comprises polypropylene.

9. The needled, non-woven of claim 1, wherein the fifth polymer comprises polyester.

10. A consolidated needled non-woven comprising:
an upper surface, a lower surface, an inner plane, a first zone extending from the upper surface to the inner plane, and a second zone extending from the inner plane to the lower surface;
wherein the first zone comprises a plurality of first core/sheath fibers, a plurality of second fibers, and a plurality of third fibers, wherein the core of the first core/sheath fibers comprises a core polymer, wherein the sheath of the first core/sheath fibers comprises a sheath polymer, wherein the core polymer has a higher melting temperature than the sheath polymer, wherein the sheath polymer has a lower surface energy than the core polymer, wherein the second fibers comprise a second polymer having a melting temperature less than the melting temperature of the core polymer of the first core/sheath fibers, wherein at least a portion of the second fibers have been at least partially to fully melted and have no defined fiber geometry, wherein the third fibers comprise a third polymer having a melting temperature at least equal or greater than the melting temperature of the core polymer of the first core/sheath fibers, wherein the second polymer and the sheath polymer of the first core/sheath fibers have a critical surface energy less than 40 mN/m, wherein the first zone comprises at least about 30% by weight first core/sheath fibers and second fibers;
wherein the second zone comprises a plurality of fourth fibers, and a plurality of fifth fibers, wherein the fourth fibers comprise a fourth polymer having a melting temperature less than the melting temperature of the core polymer of the first core/sheath fibers, wherein at least a portion of the fourth fibers have been at least partially to fully melted and have no defined fiber geometry, wherein the fifth fibers comprise a fifth polymer having a melting temperature at least equal or greater than the melting temperature of the core polymer of the first core/sheath fibers;
wherein a portion of the first core/sheath fibers, second fibers, and third fibers from the first zone are physically entangled into the fourth fibers and fifth fibers in the second zone.

11. The process of forming a needled non-woven comprising, in order:
needling a plurality of first core/sheath fibers, a plurality of second fibers, and a plurality of third fibers to form a first non-woven having an upper surface and a lower surface, wherein the core of the first core/sheath fibers comprises a core polymer, wherein the sheath of the first core/sheath fibers comprises a sheath polymer, wherein the core polymer has a higher melting temperature than the sheath polymer, wherein the sheath polymer has a lower surface energy than the core polymer, wherein the second fibers comprise a second polymer having a melting temperature less than the melting temperature of the core polymer of the first core/sheath fibers, wherein the third fibers comprise a third polymer having a melting temperature at least equal or greater than the melting temperature of the core polymer of the first core/sheath fibers, wherein the second polymer and the sheath polymer of the first core/sheath fibers have a critical surface energy less than 40 mN/m, wherein the first zone comprises at least about 30% by weight first core/sheath fibers and second fibers;
needling a plurality of fourth fibers, and a plurality of fifth fibers to form a second non-woven having an upper surface and a lower surface, wherein the fourth fibers comprise a fourth polymer having a melting temperature less than the melting temperature of the core polymer of the first core/sheath fibers, wherein the fifth fibers comprise a fifth polymer having a melting temperature at least equal or greater than the melting temperature of the core polymer of the first core/sheath fibers;
arranging the first non-woven and the second non-woven such that the lower surface of the first non-woven is adjacent to the upper surface of the second non-woven;
needling the first non-woven and the second non-woven from the upper surface of the first non-woven pushing a portion of a portion of the first core/sheath fibers, second fibers, and third fibers of the first non-woven into the second non-woven forming a needed non-woven,
wherein the upper surface of the first non-woven forms the upper surface of the needled non-woven and wherein the lower surface of the second non-woven forms the lower surface of the needled non-woven.

12. The process of claim 11, wherein the needling the first non-woven and the second non-woven is only performed from the upper surface.

13. The process of forming a consolidated, needled non-woven comprising, in order:
needling a plurality of first core/sheath fibers, a plurality of second fibers, and a plurality of third fibers to form a first non-woven having an upper surface and a lower surface, wherein the core of the first core/sheath fibers comprises a core polymer, wherein the sheath of the first core/sheath fibers comprises a sheath polymer, wherein the core polymer has a higher melting temperature than the sheath polymer, wherein the sheath polymer has a lower surface energy than the core polymer, wherein the second fibers comprise a second polymer having a melting temperature less than the melting temperature of the core polymer of the first core/sheath fibers, wherein the third fibers comprise a third polymer having a melting temperature at least equal or greater than the melting temperature of the core polymer of the first core/sheath fibers, wherein the second polymer and the sheath polymer of the first core/sheath fibers have a critical surface energy less than 40 mN/m, wherein the first zone comprises at least about 30% by weight first core/sheath fibers and second fibers;
needling a plurality of fourth fibers, and a plurality of fifth fibers to form a second non-woven having an upper surface and a lower surface, wherein the fourth fibers comprise a fourth polymer having a melting temperature less than the melting temperature of the core polymer of the first core/sheath fibers, wherein the fifth fibers comprise a fifth polymer having a melting temperature at least equal or greater than the melting temperature of the core polymer of the first core/sheath fibers;
arranging the first non-woven and the second non-woven such that the lower surface of the first non-woven is adjacent to the upper surface of the second non-woven;
needling the first non-woven and the second non-woven from the upper surface of the first non-woven pushing a portion of a portion of the first core/sheath fibers, second fibers, and third fibers of the first non-woven into the second non-woven forming a needed non-woven, wherein the upper surface of the first non-woven forms the upper surface of the needled non-woven and wherein the lower surface of the second non-woven forms the lower surface of the needled non-woven; and
consolidating the needled non-woven forming a consolidated needled non-woven using heat and optionally pressure at least partially melting the sheath of the first core/sheath fibers, the second fibers, and the fourth fibers.

14. The process of claim 13, wherein consolidating the needled non-comprises using heat and pressure.

15. The process of claim 13, further comprising molding the consolidated needled non-woven layer into a three-dimensional shape using heat and pressure.

16. The process of claim 13, wherein the consolidated needled non-woven layer has a lower thickness than the needle non-woven layer.

17. The process of claim 13, wherein the consolidated needled non-woven layer has a higher stiffness than the needle non-woven layer.

18. The process of claim 13, wherein the consolidated needled non-woven layer has a higher solidity than the needle non-woven layer.

19. The process of claim 13, wherein the first non-woven and second non-woven have a higher cohesive strength in the consolidated needled non-woven layer than the first non-woven and the second non-woven of the needle non-woven layer.

20. A needled, non-woven comprising:
an upper surface, a lower surface, a first inner plane, a second inner plane, a first zone extending from the upper surface to the inner plane, a second zone extending from the first inner plane to the second inner plane, and an additional first zone extending from the second inner plane to the lower surface;
wherein the first zone comprises a plurality of first core/sheath fibers, a plurality of second fibers, and a plurality of third fibers, wherein the core of the first core/sheath fibers comprises a core polymer, wherein the sheath of the first core/sheath fibers comprises a sheath polymer, wherein the core polymer has a higher melting temperature than the sheath polymer, wherein the sheath polymer has a lower surface energy than the core polymer, wherein the second fibers comprise a second polymer having a melting temperature less than the melting temperature of the core polymer of the first core/sheath fibers, wherein the third fibers comprise a third polymer having a melting temperature at least equal or greater than the melting temperature of the core polymer of the first core/sheath fibers, wherein the second polymer and the sheath polymer of the first core/sheath fibers have a critical surface energy less than 40 mN/m, and wherein the first zone comprises at least about 30% by weight first core/sheath fibers and second fibers;
wherein the second zone comprises a plurality of fourth fibers, and a plurality of fifth fibers, wherein the fourth fibers comprise a fourth polymer having a melting temperature less than the melting temperature of the core polymer of the first core/sheath fibers, wherein the fifth fibers comprise a fifth polymer having a melting temperature at least equal or greater than the melting temperature of the core polymer of the first core/sheath fibers; and
wherein the first zone comprises a plurality the first core/sheath fibers, a plurality of the second fibers, and a plurality of the third fibers.
